(19) United States
(12) Patent Application Publication
(10) Pub. No.: US 2017/0132479 A1
(43) Pub. Date: May 11, 2017

(54) DRIVER ASSISTANCE SYSTEM

(71) Applicant: Conti Temic microelectronic GmbH, Nurnberg (DE)

(72) Inventor: Dieter Krökel, Eriskirch (DE)

(73) Assignee: Conti Temic microelectronic GmbH, Nurnberg (DE)

(21) Appl. No.: 15/416,265

(22) Filed: Jan. 26, 2017

Related U.S. Application Data
(63) Continuation of application No. PCT/DE2015/200389, filed on Jun. 24, 2015.

(51) Int. Cl. G06K 9/00; B60Q 9/00; G05D 1/02; H04N 7/18

(52) U.S. Cl. CPC G06K 9/00791; H04N 7/183; B60Q 9/008; G05D 1/0238

(57) ABSTRACT

A driver assistance system for a motor vehicle includes an environment camera with a horizontal image angle lying around an optical axis and with an angle resolution (k) which varies over the horizontal image angle, wherein the angle resolution (k) is essentially constant in a center area (M) around the optical axis, wherein the angle resolution (k) varies in a transition area (UE), and wherein the angle resolution (k) is again essentially constant in a marginal area (R) at the edge of the horizontal image angle, further comprising an image preparation unit which is configured for preparing the image data (BD) of the environment camera for specifying a virtual angle resolution (k′), and comprising an image evaluation unit which is designed for evaluating the prepared image data (ABD).

### CROSS REFERENCE TO RELATED APPLICATION

This application claims the benefit of International application No. PCT/DE2015/200389, filed Jun. 24, 2015, which is hereby incorporated by reference.

### TECHNICAL FIELD

The technical field relates to a driver assistance system for a motor vehicle comprising an environment camera and an image evaluation unit.

BACKGROUND

Most motor vehicles from the new vehicle generation are equipped with at least one driver assistance system, such as a navigation system or so-called cruise control, which supports the driver when driving the vehicle.

Some of these driver assistance systems have an environment camera with the aid of which image data is generate which at least partially depict the environment the motor vehicle with the corresponding driver assistance system. This image data is then evaluated with the aid of an evaluation unit, in order for example to detect potential obstacles, other traffic participants or possible hazards using an object detection algorithm, against which the driver is warned for example through an acoustic or visual warning signal.

Additionally, driver assistance systems are currently being developed which are designed for at least partial fully-automated vehicle driving, i.e. in which the driver assistance system takes over full control of the corresponding motor vehicle at least for certain periods of time. These driver assistance systems, too, typically comprise at least one environment camera, wherein here, the information obtained from the evaluation of the image data is used as the basis for planning the vehicle control by the driver assistance system and thus for fully automated vehicle control.

In order to ensure that such driver assistance systems operate as reliably as possible, it is necessary for as much relevant information as possible from the environment of the corresponding motor vehicle to be depicted by the image data generated by the environment camera, and for the evaluating unit of the driver assistance system to read off the key information from this image data and thus correctly interpret the image data.

As such, it is desirable to present an advantageously designed driver assistance system. In addition, other desirable features and characteristics will become apparent from the subsequent summary and detailed description, and the appended claims, taken in conjunction with the accompanying drawings and this background.

### SUMMARY

In one exemplary embodiment, a driver assistance system for a motor vehicle includes an environment camera for generating image data, which at least partially depict the environment of the motor vehicle, and an image evaluation unit, which is configured for evaluating image data. The environment camera includes an image sensor made up of several pixels, and a lens which is preferably non-adjustable or rigid, i.e., in which the focal distance or horizontal image angle in particular cannot be varied, as is, for example, possible in some cases with photographic cameras or so-called digital cameras. However, in order to be able to depict different objects at different distances to the motor vehicle with sufficiently sharp focus, the environment camera is further configured in such a manner that a horizontal image angle lying around an optical axis is provided, wherein the angle resolution of the environment camera varies over the horizontal image angle. In this manner, the environment camera is on the one hand kept relatively simple, and on the other is adapted to the specific requirements for use in a motor vehicle as part of a driver assistance system.

In one exemplary embodiment, the driver assistance system is configured in such a manner that on the one hand, as far as possible, all relevant information from the environment or at least the area in front of the corresponding motor vehicle should be recorded and depicted with the aid of the environment camera, so that it is included in the image data generated by the environment camera, while on the other hand, the computing effort during the automated evaluation of image data in the image evaluation unit should be kept as low as possible, wherein at the same time, it should be ensured that the image evaluation unit reliably reads off all relevant information from the image data when evaluating the image data or detects it in the image data. In this manner, it is ensured that the evaluation of image data progresses rapidly and the image data can be correctly interpreted.

This goal is achieved in particular by means of the solution approaches described below. Furthermore, the different solution approaches can also be advantageously combined with each other.

According to one of these solution approaches, the driver assistance system is configured in such a manner that the angle resolution of the environment camera is constant in a center area around the optical axis, varies in a transition area directly adjacent to it and is again essentially constant in a marginal area at the edge of the image angle directly adjacent to the transition area. Additionally, in this exemplary embodiment, the driver assistance system includes an image preparation unit which is configured for preparing image data generated by the environment camera for the specification of a virtual angle resolution. Here, the image preparation unit generates prepared image data based on the image data generated by the environment camera, which are subsequently evaluated in the image evaluation unit.

This means, therefore, that the image data generated by the environment camera is first adapted with the aid of algorithms stored in the image preparation unit and is thus changed before it is later evaluated in the image evaluation unit according to the generally known principle. For the treatment, scaling algorithms are used, for example as they are known in principle from the field of entertainment electronics, wherein a reduction in resolution, for example through the compilation of several pixels, i.e., a replacement of several pixels by a new virtual pixel, is achieved and wherein an increase in resolution is achieved for example through the generation of additional virtual pixels through interpolation. The preparation of the image data in the image preparation unit here causes a reduction in image distortions, for example, which result from the varying angle resolution of the environment camera. Image distortions of this nature are here calculated out, as it were, from the image data generated by the environment camera in order to facilitate object recognition, for example, with the aid of the image evaluation unit.

Since the environment camera typically generates a series or sequence of individual images during operation, it is also advantageous when the image preparation unit is installed in such a manner that the angle resolution of each individual image is adapted during preparation in accordance with a stored pattern, wherein advantageously, the same model is used for each individual image. However, here, there is preferably no simple scaling up or scaling down of all the individual images; instead, only one very specific area within each individual image is prepared, so that the resolution, i.e., the angle resolution, is adapted only in this area.

The angle resolution is adapted in a further preferred manner in the transition area of each individual image, i.e., in the area in which the angle resolution within the horizontal image angle in the individual images generated by the environment camera varies depending on the angle in relation to the optical axis. Here, it is provided, for example, that the angle resolution in the transition area is downscaled to the angle resolution in the marginal area, so that the angle resolution, or rather the virtual angle resolution, in the prepared image data, i.e., in the prepared individual images, is essentially constant over the entire center area and the entire marginal area. Alternatively, the angle resolution in the transition area is upscaled to the angle resolution in the center area.

According to a further alternative, the transition area is virtually divided into a first partial transition area immediately adjacent to the center area, and a second partial transition area immediately adjacent to the marginal area, wherein for this purpose, a delimiting angle is stored in a memory of the image preparation unit which determines the border between the two partial transition areas. Advantageously, the angle resolution is then virtually increased in the first transition area during the preparation in the image preparation unit, and is thereby in particular upscaled to the angle resolution in the center area. Additionally, it is advantageous that the angle resolution in the second partial transition area is virtually reduced during the preparation, and is here in particular downscaled to the angle resolution in the marginal area.

If therefore an essentially constant angle resolution with different values is now given in a center area and a marginal area respectively, and if the angle resolution in the intermediate area between the center area and the marginal area gradually decreases from the value of the angle resolution in the center area to the value of the angle resolution in the marginal area, the image data is preferably prepared in such a manner that in the prepared image data, in particular in the individual images, the angle-dependent virtual angle resolution starting from the optical axis through to the delimiting angle is constant, reduces in major increments or in stages to the value of the angle resolution in the marginal area, and then remains essentially constant from the delimiting angle up to the edge of the horizontal image angle.

In this way, in the individual images, a central area with a larger angle resolution and an area with a lower angle resolution directly surrounding said central area are provided, wherein between these two areas, there is a clear border. A transition area or transition zone in which the angle resolution gradually reduces from the higher to the lower value, as is provided in the individual images generated by the environment camera, is thus no longer present in the prepared individual images. It is precisely the angle resolution which gradually changes with the angle which typically cases a distorted depiction of objects depicted in the angle range belonging to the transition area, and these distortions are downscaled, as it were, by adapting the angle resolution. As a result, it is easier to detect the objects in the image evaluation unit.

A driver assistance system according to the second solution approach also comprises an environment camera with a horizontal image angle lying around an optical axis and with an angle resolution, k=k(α), which varies over the horizontal image angle. Here, the angle resolution k is again essentially constant, starting from the optical axis α_{OA}=0° up to an angle α₁, with α₁>α_{OA}, decreases between the angle α₁ and an angle α₂ as the angle α increases, and then starting from angle α₂>α₁ up to the edge of the horizontal image angle α_{R}, is essentially constant, with α_{R}>α₂. Here, however, the angle resolution between α₁ and α₂ is specified in such a manner that the decrease in the angle resolution k(α)<(k₁/f)/α₁ is, with the specified angle resolution k₁, at α₁. Here, it is also specified by means of f by which factor the resolution should be reduced between α₁ and α₂. Here, a factor is preferably selected which corresponds to an integral multiple of 2, i.e. f=2, for example.

Through the limitation or specification of a maximum value for the decrease in the angle resolution, it is ensured that the object detection with the driver assistance system is possible in a specified distance range to the motor vehicle, regardless of the distance. Here, it should be taken into account that for object detection, a minimum resolution is typically required, as a result of which a minimum requirement emerges with regard to the angle resolution. Each minimum requirement with regard to the angle resolution is however reduced by a specified resolution requirement for the object detection with a decreasing distance between the motor vehicle with the driver assistance system and the object to be detected, so that the angle-dependent angle resolution of the environment camera can decrease within a certain degree with an increasing angle, without failing to meet the minimum requirement for the resolution or minimum resolution as a result.

This fact is easy to comprehend on the basis of a simple consideration. If one assumes that the road runs straight and that there is a traffic sign positioned on the side of the road, the depiction of the traffic sign in an ongoing sequence of individual images will gradually move from a center area of the individual images into a marginal area of the individual images, and while doing so will become increasingly larger in relation to the image size of the individual images when the vehicle with the driver assistance system moves towards the traffic sign. Since the width of the traffic sign, for example, must be depicted by a certain minimum number of pixels in the individual image in order to detect the traffic sign, and the size of the traffic sign increases the further the traffic sign moves in the direction of the edge of the individual images, the angle resolution requirement is reduced with an increasing angle starting from the optical axis up to the edge of the individual images. It is thus possible, for example, to specify that a certain object such as a traffic sign is shown in the individual images of the environment camera through a fixed number of pixels, wherein in this border case, the enlargement of the depiction of the traffic sign during the decreasing distance between the motor vehicle with the driver assistance system and the traffic sign is compensated precisely by the decreasing angle resolution with the increasing angle. This border case can be estimated and requires a decrease in the angle resolution of (k₁/f)/α₁.

Naturally, this is an approximation, in which the fact is neglected, among others, that the viewing angle onto the traffic sign changes with the distance to the traffic sign. It was also assumed in a simplified manner that with the environment camera, a 2D distribution of the angle resolution is given which is rotationally symmetric to the optical axis, and that the traffic sign moves along a straight line, as it were, which runs radially outwards starting from the optical axis. However, through more precise calculations, a more precise value or a functional relationship can easily be determined.

If one now selects the progression of the angle resolution in accordance with the border value condition described above, it is achieved on the one hand that the object detection is possible regardless of the distance in the specified distance range, and on the other, the number of pixels required is kept at a low level. Here, it should be considered that with the increasing angle resolution, the number of pixels required also increases, as a result of which the effort involved in production and the costs for a corresponding environment camera increase. Therefore, if a considerably smaller or weaker decrease is selected for the angle resolution than would actually be required in order to fulfill the resolution requirement for the object detection, this also means that more pixels must be provided than are actually necessary, and that accordingly, greater production effort and higher production costs must be planned. If a greater or stronger decrease is selected, it is equally the case that more pixels must be provided than are actually necessary, since in this case, al must be larger in order to still be able to fulfill the resolution requirements in the overall transition area.

According to the third solution approach, the environment camera of the driver assistance system is designed in such a manner that the angle-dependent angle resolution of the environment camera shows a graded progression. The driver assistance system is here again designed for a motor vehicle, and comprises an environment camera with a horizontal image angle lying around an optical axis and with an angle resolution which varies over the horizontal image angle. Here, again, the angle resolution is essentially constant in a center area around the optical axis and the angle resolution is again essentially constant in a marginal area at the edge of the image angle. However, with this embodiment, the marginal area borders directly on the center area. Since in addition, the angle resolution in the center area deviates from the angle resolution in the marginal area, the angle resolution on the border changes between the center area and the marginal area without a transition, i.e. in a sudden, major way from one value in the center area to a second value in the marginal area, which is advantageously lower. In accordance with the basic concept of this embodiment variant, the environment camera thus comprises an angle resolution with two discrete values, as a result of which the image data generated by the environment camera can be prepared and/or evaluated more easily. Here, the focus is in particular on simplified data processing.

Alternatively, several discrete values for the angle resolution are provided for several areas, and in this case, the angle resolution shows several sudden major changes between discrete values, so that the angle resolution shows a stair-like progression, for example.

Also in the case of the fourth solution approach, the driver assistance system is again designed for a motor vehicle, and comprises an environment camera with a horizontal image angle lying around an optical axis and with an angle resolution which varies over the horizontal image angle. There, the angle resolution is again essentially constant in a center area around the optical axis on the one hand and in a marginal area at the edge of the image angle on the other. Additionally, the angle resolution in the center range corresponds, however, to an integral multiple of the double angle resolution in the marginal area, i.e., in the simplest case, to the double angle resolution in the marginal area.

This relation between the angle resolution in the center area and the angle resolution in the marginal area is realized with all embodiment variants of the driver assistance system presented here, since as a result, the data processing, and in particular a preparation of image data in an image evaluation unit, is considerably simpler.

For the solution approaches described above and the resulting embodiment variants of the driver assistance system, an angle resolution is also realized, the progression of which lies within the horizontal image angle symmetrical to the optical axis. If, for example, one enters the angle-dependent progression of the angle resolution into a Cartesian coordinate system, the progression of the angle resolution has symmetrical axes to the coordinate axis, with the angle resolution values.

Furthermore, the angle resolution, or more precisely the two-dimensional distribution of the angle resolution, is preferably rotationally symmetric to the optical axis, so that the center area is provided by a circular surface, and the marginal area is provided by a ring-shaped surface.

Additionally, the environment camera with all the driver assistance systems described above preferably comprises an optical system and an image sensor made up of a plurality of pixels. Here, the pixels of the image sensor are further preferably uniformly designed, i.e. they also have a uniform size, and furthermore are distributed evenly over the entire sensor surface of the image sensor. The non-uniform angle resolution is accordingly preferably specified by the optical system. Here, the optical system is for example cylindrically symmetrical or elliptical, or are rotationally symmetrical to the optical axis.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram showing a motor vehicle with a driver assistance system including an environment camera according to one exemplary embodiment;

FIG. 2 is a diagram showing a two-dimensional angle resolution of the environment camera according to one exemplary embodiment;

FIG. 3 is a chart showing the progression of the angle resolution of the environment camera within a half horizontal image angle according to one exemplary embodiment; and

FIG. 4 is a geometric depiction of the specified marginal conditions for an advantageous progression of the angle resolution within the half horizontal image angle according to one exemplary embodiment.

### DETAILED DESCRIPTION

Parts which correspond to each other are assigned the same reference numerals respectively in all figures.

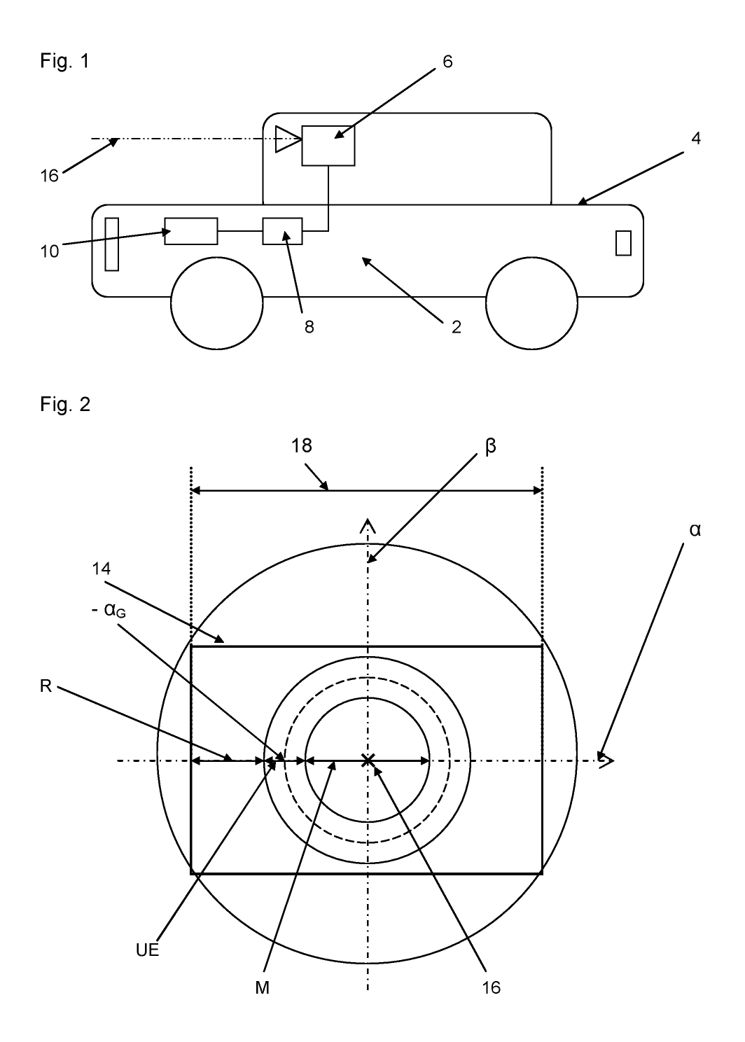

A driver assistance system 2, which will be described below as an example and which is sketched in FIG. 1, is integrated into a motor vehicle 4 and comprises an environment camera 6, an image preparation unit 8, and an image evaluation unit 10. The environment camera 6 serves to generate image data BD, which depicts the environment of the motor vehicle 4, more precisely the area in front of the motor vehicle 4. This image data BD is then transmitted via a signal line (not numbered) to the image preparation unit 8 and is prepared in the image preparation unit 8. The image preparation unit 8 issues prepared image data ABD, which is transmitted on to the image evaluation unit 10 via a signal line, and is evaluated by the image evaluation unit 10 according to the known principle.

Within the scope of this evaluation, for example, objects such as obstacles or other traffic participants are then detected by means of an object detection algorithm and additionally, the distances between the motor vehicle 4 with the driver assistance system 2 and the detected objects are determined. Depending on the embodiment variant of the driver assistance system 2, the information obtained during the evaluation of the image data ABD is ultimately used to either support a driver of the motor vehicle 4 in driving the vehicle, wherein said driver is for example notified by means of optical and/or acoustic signals of obstacles or other traffic participants, or also in order to realize fully automated vehicle driving by the driver assistance system 2 on the basis of this information.

In order to generate the image data BD, the environment camera 6 in this exemplary embodiment includes an optical system 12 and an image sensor 14, which is made up of a plurality of pixels (not shown). Here, the pixels have a uniform design and a uniform size and are uniformly distributed over the entire sensor surface of the image sensor 14.

Further, the optical system 12 is configured in such a manner that through them, a uniform angle resolution k=k(α) is provided with the environment camera 6. For this purpose, the environment camera 6 comprises a symmetric image angle 18 which lies around an optical axis 16, wherein the angle resolution k varies depending on the angle α over the horizontal image angle 18. The progression of the angle resolution k is here such that the angle resolution k is constant in an center area M around the optical axis 16, varies in a transition area UE directly adjacent to the center area M, and is again constant in a marginal area R at the edge of the horizontal angle 18 which is directly adjacent to the transition area UE.

The angle-dependent progression of the angle resolution k within the horizontal image angle 18 with the edges −α_{R} and +α_{R} is here also symmetric to the optical axis 16 at α_{OA}=0°, so that k(−α)=k(α) applies. The angle α here runs from −α_{R} to +α_{R} with +/−α_{R}=+/−25°. The horizontal image angle 18 is accordingly 2α_{R}=50°.

Furthermore, the two-dimensional angle resolution k_{2D}=k_{2D}(α, β) which is determined by the optical system, or the 2D distribution of the angle resolution k_{2D} is rotationally symmetric to the optical axis 16, so that the center area M, as indicated in FIG. 2, is provided by a circular surface and the transition area UE on the one hand and the marginal area R on the other are provided respectively by a ring-shaped surface.

Also, the image sensor 14 is indicated in FIG. 2, with the aid of which individual images are generated in a continuous sequence during the operation of the environment camera 6. This image sensor 14 may, as described above, have a uniform resolution over the entire sensor surface, but due to the design of the optical system 12, different spatial angles are projected onto the individual pixels of the image sensor 14, depending on which area of the optical system 12 is assigned to the corresponding pixel. Accordingly, in each individual image, if this is shown 1:1, i.e. for example via a screen with the same number of pixels as the image sensor 14, in which the pixels are also uniformly designed and uniformly distributed, a distorted depiction of the environment is provided. Here, in the center area M of each individual image, a larger number of pixels form a spatial angle unit than in the remaining areas, so that the image data BD shows the distribution of the angle resolution k specified by the optical system 12.

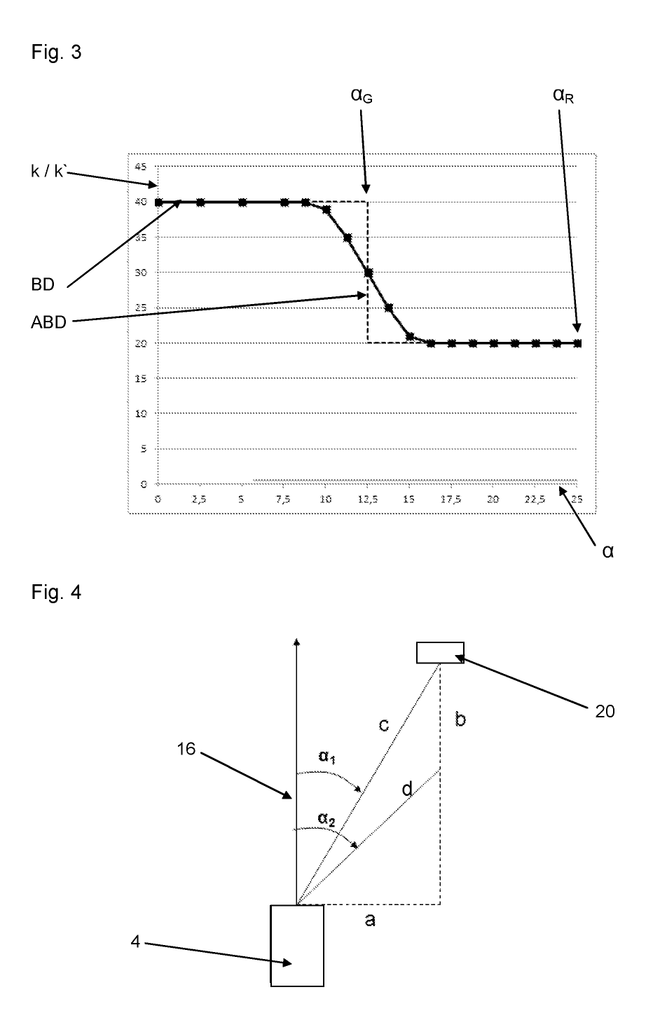

The progression of the angle resolution k thus realized is shown in FIG. 3 for a half of the horizontal image angle 18 in a diagram. Here, a runs from 0°, i.e. starting from the optical axis 16, to 25°, which corresponds to the right edge of the horizontal image angle +αR. Due to the symmetrical progression of the angle resolution k, the progression of the angle resolution k is obtained within the second half of the horizontal image angle 18 by a reflection on the axis k(α) of the Cartesian coordinate system.

Here, the unbroken line in the diagram shows the progression of the angle resolution k depending on the angle α, as it is realized with the aid of the special design of the optical system 12 for the environment camera 6 and shown in the image data BD generated by the environment camera 6. In the image preparation unit 8, the image data BD generated by the environment camera 6, as mentioned above, is prepared and here converted into prepared image data ABD. As a result of this preparation, the angle resolution k(α) is also adjusted, so that the prepared image data ABD show an angle resolution k′=k′(α) which is indicated in FIG. 3 by the broken line. Since the adjustment is made within the scope of data processing, the angle resolution k′ is also described as a virtual resolution k′.

The preparation is here conducted individual image for individual image, wherein only that image data BD of each individual image is adjusted which depicts the transition area UE. For this purpose, in the image preparation unit 8 a delimiting angle α_{G}=12.5° is stored which divides the transition area UE, which lies between α₁=8.5° and α₂=16.5°, into two transition partial areas. Within the scope of the preparation of the image data α₁ and α_{G}, a virtual increase of the angle resolution k occurs, wherein for this purpose, additional virtual pixels are generated through interpolation. Additionally, in the second transition partial area from α_{G} to α₂, a virtual decrease or reduction of the angle resolution k occurs, whereby several pixels are compiled to create one virtual new pixel.

As a result, the prepared image data ABD shows an angle resolution k′ with k′(α)=40 pixels/° for α ∈ [α_{OA}; α_{G}] and with k′(α)=20 pixels/° for α ∈ [α_{G}; α_{R}]. For the angle resolution k′(α), only two discreet values are therefore still given, wherein with the delimiting angle α_{G}, a sudden major transition occurs between these two values. Within the scope of the preparation of the image data BD, a type of rectification of the progression of the angle resolution k occurs. A similar adjustment is also made with the progression of the angle resolution k within the second half of the horizontal image angle 18, so that k′(α)=40 pixels/° for α ∈ [α_{OA}; −α_{G}] and with k′(α)=20 pixels/° for α ∈ [−α_{G}; -α_{R}] applies. The principle related to this is additionally transferred to the two-dimensional angle resolution k_{2D}=k_{2D}(α,β).

The image data ABD thus prepared is then transmitted to the image evaluation unit 10, wherein the evaluation of the prepared image data ABD is simpler due to the preparation, in particular with regard to data processing. Of equal benefit for the data processing is the fact that the two discreet values of the virtual angle resolution k′(α) are selected in such a manner that for these, a ratio of 2:1 is provided.

With a further exemplary embodiment described below, the optical system 12 of the environment camera 6 are designed in such a manner that the angle resolution k(α) is constantly 50 pixels/° up to an angle α₁=10°, then decreases by 2.5 pixels/°)/° up to an angle α₂=20°, and finally, starting from an angle α₂ up to the edge of the horizontal image angle α_{R} is constant at 25 pixels/°, wherein for the sake of simplicity, only the one-dimensional case and only a half of the horizontal image angle 18 is considered.

In this manner, a certain object, here a traffic sign 20, should be shown by a fixed number of pixels in the individual images of the environment camera 6 in a specified distance range in front of the motor vehicle 4, wherein in this special case, the enlargement of the representation of the traffic sign 20 is precisely compensated during the decreasing distance between the motor vehicle 4 with the driver assistance system 2 and the traffic sign 20 in this distance range by the angle resolution k which is decreasing by the increasing angle α.

Here, it is assumed that the road runs straight, and that there is a traffic sign, which is on the side of the road and thus, as sketched in FIG. 4, is positioned at a side distance a to the motor vehicle 4. Additionally, it is assumed for the sake of simplicity that with the environment camera 6 a 2D distribution of the angle resolution k2D is provided which is rotationally symmetric to the optical axis 16, and that the traffic sign 20 runs along a straight line, as it were, in the individual images, which starting from the optical axis 16 runs radially outwards.

The traffic sign 20 should now be detected up to a distance c by the driver assistance system 2, for the purpose of which as an example, a resolution k(α₁=10°)=k₁=50 pixels/° is required. At the distance d=c/2, only half the resolution k₂(α₂=20°)=k₂=k₁/2=25 pixels/° is required for detecting the traffic sign 20.

Here, the fact is ignored, among others, that the traffic sign 20 also appears somewhat smaller due to the parallax with larger angles α, since the viewing angle onto the traffic sign 20 changes, as it were, with the distance to the traffic sign 20. This error is proportionate to (cos α₁−cos α₂) and for small angles α, at least in this consideration, is negligible (e.g. the value of cos α changes by 4.5% between 10° and 20°). For a more precise estimate, therefore, the resolution k should again be increased by this value in order to guarantee a continued sufficient resolution k.

The change to the resolution k between the angles α1 and α2 should then be:

(k₁/2)/(α₁−α₂)

or:

$$\frac{{k}_{1} / 2}{arcsin ( \frac{2 a}{c} ) - arcsin ( \frac{a}{c} )}$$

with a/c=sin α₁ the result is:

$$\frac{{k}_{1} / 2}{arcsin ( 2 sin {∝}_{1} ) - arcsin ( sin {∝}_{1} )}$$

or:

$$\frac{{k}_{1} / 2}{arcsin ( 2 sin {∝}_{1} ) - {∝}_{1}}$$

For small angles α₁, arc sin(2 sinα₁) is approximately equal to 2α₁, so that the following results for the decrease in resolution:

$$\frac{{k}_{1}}{\frac{2}{{∝}_{1}}}$$

If therefore the traffic sign 20 should be detected with an aperture angle of α₁=10°, and if an angle resolution of k₁(α₁)=50 pixels/° is necessary for this purpose, the optical system 12 should be designed in such a manner that the angle resolution k decreases for larger angles α>α₁ with (25) pixels/°/10°=(2.5 pixels/°)/°.

The invention is not restricted to the exemplary embodiment described above. To a far greater extent, other variants of the invention can be derived from this by persons skilled in the art without departing from the subject of the invention. Furthermore, in particular all individual features described in connection with the exemplary embodiment can also be combined with each other in another manner without departing from the subject of the invention.

What is claimed is:

1. A driver assistance system for a motor vehicle, comprising:
an environment camera with a horizontal image angle lying around an optical axis and with an angle resolution (k) which varies over the horizontal image angle;
wherein the angle resolution (k) is essentially constant in a center area (M) around the optical axis;
wherein the angle resolution (k) varies in a transition area (UE); and
wherein the angle resolution (k) is again essentially constant in a marginal area (R) at the edge of the horizontal image angle,
an image preparation unit configured for preparing the image data (BD) of the environment camera for specifying a virtual angle resolution (k′); and
an image evaluation unit which is configured for evaluating the prepared image data (ABD).

2. The driver assistance system according to claim 1, wherein the environment camera generates a sequence of individual images during operation, and wherein the image preparation unit is configured in such a manner that the angle resolution (k) of each individual image is adapted in accordance with a stored pattern.

3. The driver assistance system according to claim 2, wherein only the angle resolution (k) in the transition area (UE) of each individual image is adapted in accordance with a stored pattern.

4. The driver assistance system according to claim 1, wherein a delimiting angle (αG) is stored in a memory of the image preparation unit, which virtually divides the transition area (UE) into a first partial transition area, which is adjacent to the center area (M), and a second partial transition area, which is adjacent to the marginal area (R), and wherein the angle resolution (k) in the first partial transition area is virtually increased during the preparation in the image preparation unit, in particular upscaled to the angle resolution (k) in the center area (M).

5. The driver assistance system according to claim 1, wherein a delimiting angle (α_{G}) is stored in a memory of the image preparation unit, which virtually divides the transition area (UE) into a first partial transition area, which is adjacent to the center area (M), and a second partial transition area which is adjacent to the marginal area (R), and wherein the angle resolution (k) in the second partial transition area is virtually decreased during the preparation in the image preparation unit, in particular downscaled to the angle resolution (k) in the marginal area (R).

6. The driver assistance system according to claim 1, wherein the horizontal image angle lies symmetrically around the optical axis, and wherein the angle-dependent progression of the angle resolution (k) within the horizontal image angle is symmetrical to the optical axis.

7. The driver assistance system according to claim 1, wherein the 2D distribution of the angle resolution (k_{2D}=k_{2D}(α,β)) is rotationally symmetrical to the optical axis.

8. The driver assistance system according to claim 1, wherein the environment camera comprises an optical system and an image sensor made up of a plurality of pixels, wherein the pixels have a uniform design and are uniformly distributed, and wherein a non-uniform angle resolution (k) is specified by the optical system.

9. A driver assistance system for a motor vehicle, comprising:
an environment camera with a horizontal image angle lying around an optical axis and with an angle resolution k=k(α) which varies over the horizontal image angle,
wherein the angle resolution k is essentially constant, starting from the optical axis α_{OA} up to an angle α₁>α_{OA},
wherein the angle resolution k is again essentially constant, starting from an angle α₂>α₁ up to the edge of the horizontal image angle α_{R}>α₂,
wherein the angle resolution k decreases between α₁ and α₂ as the angle α increases, and
wherein the decrease in the angle resolution k=k(α) is less than (k₁/2)/α₁, with the specified angle resolution k₁ at α₁.

10. The driver assistance system according to claim 9, wherein the horizontal image angle lies symmetrically around the optical axis, and wherein the angle-dependent progression of the angle resolution (k) within the horizontal image angle is symmetrical to the optical axis.

11. The driver assistance system according to claim 9, wherein the 2D distribution of the angle resolution (k_{2D}=k_{2D}(α,β)) is rotationally symmetrical to the optical axis.

12. The driver assistance system according to any one of the preceding claims,
wherein the environment camera comprises an optical system and an image sensor made up of a plurality of pixels, wherein the pixels have a uniform design and are uniformly distributed, and wherein a non-uniform angle resolution (k) is specified by the optical system.

13. A driver assistance system for a motor vehicle, comprising:
an environment camera with a horizontal image angle lying around an optical axis and with an angle resolution (k) which varies over the horizontal image angle,
wherein the angle resolution (k) is essentially constant in a center area (M) around the optical axis,
wherein the angle resolution (k) is essentially constant in a marginal area (R) at the edge of the horizontal image angle essentially directly adjacent to the center area (M), and
wherein the angle resolution (k) in the center area (M) deviates from the angle resolution (k) in the marginal area (R).

14. The driver assistance system according to claim 13, wherein the horizontal image angle lies symmetrically around the optical axis, and wherein the angle-dependent progression of the angle resolution (k) within the horizontal image angle is symmetrical to the optical axis.

15. The driver assistance system according to claim 13, wherein the 2D distribution of the angle resolution (k_{2D}=k_{2D}(α,β)) is rotationally symmetrical to the optical axis.

16. The driver assistance system according to claim 13, wherein the environment camera comprises an optical system and an image sensor made up of a plurality of pixels, wherein the pixels have a uniform design and are uniformly distributed, and wherein a non-uniform angle resolution (k) is specified by the optical system.

17. A driver assistance system for a motor vehicle, comprising:
an environment camera with a horizontal image angle lying around an optical axis and with an angle resolution (k) which varies over the horizontal image angle;
wherein the angle resolution (k) is essentially constant in a center area (M) around the optical axis;
wherein the angle resolution (k) is essentially constant in a marginal area (R) at the edge of the horizontal image angle; and
wherein the angle resolution (k) in the center area (M) corresponds to an integral multiple of the double angle resolution (k) in the marginal area (R).

18. The driver assistance system according to claim 17, wherein the horizontal image angle lies symmetrically around the optical axis, and wherein the angle-dependent progression of the angle resolution (k) within the horizontal image angle is symmetrical to the optical axis.

19. The driver assistance system according to claim 17, wherein the 2D distribution of the angle resolution (k_{2D}=k_{2D}(α,β)) is rotationally symmetrical to the optical axis.

20. The driver assistance system according to claim 17, wherein the environment camera comprises an optical system and an image sensor made up of a plurality of pixels, wherein the pixels have a uniform design and are uniformly distributed, and wherein a non-uniform angle resolution (k) is specified by the optical system.
